(19) United States
(12) Patent Application Publication
(10) Pub. No.: US 2014/0280052 A1
(43) Pub. Date: Sep. 18, 2014

(54) KNOWLEDGE DISCOVERY USING COLLECTIONS OF SOCIAL INFORMATION

(71) Applicant: MICROSOFT CORPORATION, Redmond, WA (US)

(72) Inventors: Omar Alonso, Redwood Shores, CA (US); Hemant Banavar, Santa Clara, CA (US); Marc Eliot Davis, San Francisco, CA (US); Kartikay Khandelwal, Los Altos, CA (US)

(73) Assignee: MICROSOFT CORPORATION, Redmond, WA (US)

(21) Appl. No.: 13/830,944

(22) Filed: Mar. 14, 2013

(51) Int. Cl. G06F 17/30

(52) U.S. Cl. CPC G06F 17/30554
USPC 707/722

(57) ABSTRACT

Architecture that enables access to high quality summaries of trending topics of social media data, and presents to a consumer an aggregated view of the social activity of a unit of information of interest across different networks (and then defined by increments of time, if desired). The social network data is mined to extract associated attributes as well as popular hashtags, links, etc. This provides a consumer with a single interface for all relevant social activity associated with a user query and enable the capability to browse through the unit(s) of information via the interface. The user can also follow (track) the unit(s) of information of interest as well as receive personalized notifications (e.g., emails) thereby keeping the consumer current with trends on a time basis (e.g., daily, weekly, etc.).

### BACKGROUND

The growing popularity of social networks (e.g., Twitter™, Facebook™) has resulted in a wealth of user-generated content about different entities (e.g., such as topics, people, etc., or more generally referred to as units of information). However, this explosion in social data also spawns the problem of information overload for the consumer of this data. Existing systems require that users explicitly enter terms that represent keywords or topics, which are then queried across other networks to determine if these terms are mentioned in the other networks; however, this is a string-based approach, and requires the user to direct the search across the desired networks. Moreover, the search using keywords or topics requires the user to generate the words, rather than having the subject emerge from the data. As it currently stands, there is no approach aggregates the social user-generated information obtained from across different social networks.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables access to collections of high quality summaries of trending topics of social media data, aggregates the user-generated social information obtained from the social networks, and presents the information to a consumer (e.g., user) as an aggregated view of the social activity. This identifies one or more unit(s) of information of interest across different networks and as defined by units and/or spans of time. The social network data is mined to extract associated attributes (also included as units of information) as well as popular hashtags (tags or terms that use a preceding symbol “#”), links (e.g., URLs (uniform resource locators)), etc. For example, a unit of information can be a specific person, Celebrity A, having attributes of “movies starred in”, “age”, “picture of”, and so on. A unit of information can also be a topic of discussion such as “jobs” with attributes related to demographics.

This provides a consumer with a single user interface for all relevant social activity associated with a user query and enables the capability to browse through the units of information via the user interface. This is a novel form of knowledge discovery. The user can also follow (track) the unit of information of interest as well as receive personalized notifications (e.g., emails) thereby keeping the consumer current with trends on a time basis (e.g., daily, weekly, etc.).

The architecture discloses a method of mining the collections of social data to group the social data by units of information (e.g., topics) and then obtaining trend data such as associated keywords, hashtags, media, links, questions/answers, and updates, for example. Units of information can be annotated and indexed, and broken down by time as well.

The user interface enables the user to browse through the social data, discover connections between information, study daily, weekly, monthly, and yearly trends and, reasons for the trends and the associated trending information. The user interface enables the user (consumer) to identify a specific unit of information of interest and then track that unit of information over time. A notification service (e.g., email, instant messaging, etc.) sends periodic (e.g., weekly) notifications to the user, customized to the user interests and preferences, to keep the user current with the trends of unit(s) of information in which they have an interest.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system that further comprises a presentation component and a notification component.

FIG. 3 illustrates an exemplary aggregated view in accordance with the disclosed architecture.

FIG. 4 illustrates a more specific exemplary aggregated view based on the generalized aggregated view of FIG. 3.

FIG. 5 illustrates an exemplary notification that presents an aggregated view of a trend summary across the social networks to a user.

FIG. 6 illustrates a system of indexing keys and collections of summaries into an index that can be queried in realtime for population of the aggregated view in accordance with the disclosed architecture.

FIG. 7 illustrates a method in accordance with the disclosed architecture.

FIG. 8 illustrates an alternative method in accordance with the disclosed architecture.

FIG. 9 illustrates a block diagram of a computing system that executes knowledge discovery using social media collections of information in accordance with the disclosed architecture.

### DETAILED DESCRIPTION

The disclosed architecture accesses collections of high quality summaries of trending topics of social media data, and presents to a consumer (e.g., user) an aggregated view of the social activity of a unit of information across different networks and then defined by increments of time. The social network data is mined (searched) to extract associated properties as well as popular hashtags, links (e.g., URLs (uniform resource locators)), etc.

A unit of information is a well-known term or terms that identify a person, place, organization, company, subject, topic, or other interest. Additionally, units of information need not match physical real-world objects. A unit of information effectively models globally-unique identified semantic spaces or objects. The unit of information can map to multiple items, can be anything that is currently being “talked” about at a point in time, and captures the attention of myriad people.

This provides a consumer with a single interface for all relevant social activity (as defined by social trending data) associated with a user query and enables the capability to browse through the unit(s) of information via the interface. This is a novel form of knowledge discovery. The user can also follow (track) the unit(s) of information (of interest) as well as receive personalized notifications (e.g., emails) thereby keeping the consumer current with trends on a time basis (e.g., daily, weekly, etc.).

The architecture discloses a method of mining the collections of social data to group the social data by unit(s) of information and then obtaining trend data such as associated keywords, hashtags, media, links, questions, and updates. Units of information can be annotated and indexed, broken down by time.

A user interface enable users to browse through the social data, discover connections between information, study daily, weekly, monthly, and yearly trends and, reasons for the trends and the associated trending information. The user interface enables the user (consumer) to identify a specific unit of information of interest and then track that entity over time. A notification service (e.g., email, instant messaging, etc.) sends periodic (e.g., weekly) notifications to users, customized to the user interests, to keep the user current with the trends of unit of information in which they have an interest.

Given collections of social data (trend summaries) for a single day, for example, the summaries are mined to extract popular n-grams (e.g., units of information in the form of unigrams, bigrams, etc.) associated with each collection. The top k hashtags and URLs associated with that collection are extracted. For each unit of information, the weight associated with that unit is calculated. The weight is used for ranking, as well as in the user interface for the aggregated view to the user. The list of popular n-grams is then joined with a list of known units of information to obtain the units of information associated with that collection (and social network).

All this information is then indexed using a data structure, where the unit of information is used as the key, and a list of summaries associated with that unit of information, as attributes. This data structure can be queried in realtime (processed in the timespan that the actual event is occurring) and is used to populate the aggregated view shown to the user in the user interface.

The aggregated view includes a timeline which maps the popularity of a unit of information in question over time. Specifically, the aggregated view has the following features. A temporal view of a popular unit of information presents a snapshot of the different times that the particular popular unit of information was trending over a given time span. The data points on the temporal view (e.g., timeline) are associated with a summary of the reasons for the trend or popularity (e.g., trending hashtags on that day, popular questions, etc.).

Another feature is a list of the top popular attributes associated with the unit of information. A click on an attribute (another unit of information) initiates a re-query that takes the user to a similar page, which relates to the clicked attribute. This enables the user to browse, and is particularly useful for knowledge discovery in the cases where the user is not sure what is being looked for.

Another feature is a list of popular hashtags (which when selected, again, re-query to a similar page) and a list of popular URLs, which gives the user a look into media activity (e.g., news articles, pictures, videos, etc.) related to the unit of information on a given day.

Another feature is the ability to follow the unit of information and receive personalized updates about the unit of information. This enables the user to indicate to a search engine the unit(s) of information that the user considers interesting and, in turn, enables the search engine to provide the user daily/weakly/monthly updates about the units of information (especially events) that the user cares about.

The disclosed architecture is entity-based, in contrast with existing systems, which are string-based. Although the description herein generally focuses on features associated with a commonly-known social network, Twitter™, it is to be understood that this is simply one example, and is not intended to be construed as so limited.

Each social media network can have a model of trending its information. The disclosed architecture builds a unit of information and trending model that is cross-network. The cross-social network realtime trending based on a common entity (or unit of information) model then determines the relevance of trending data from multiple sources.

The architecture performs extraction and disambiguation of a given unit of information from the social feeds (e.g., news) across multiple social network feeds. This differentiates from conventional approaches, where both realtime and social aspects are computed, in contrast to the extraction of webpages, for example. In social networks, the authors are known, the relationships to each other are known, as well as the timing of the utterances. Thus, this type of metadata enables the building of a different model that is not otherwise realized.

The frequency of notification can be driven by a change, not only in the type of unit of information, but in combination with or separately by a change in magnitude/value of a given unit of information. For example, if the user has indicated a specific interest in a unit of information related to stock information, as being determined as trending data on the social networks, the notification can be configured to be sent more frequently. This can also apply to road and weather conditions, and so on. Contrariwise, if the unit of information trending across the networks relates to the latest fishing conditions on a given lake, and which the user has little interest, the notification can be provided at a much lower frequency, if at all. Similarly, if the unit of interest relates to a specific value or deviation about the specific value, the transmission of the notification can be tailored to occur more or less frequently according to the interest of the user in the value.

It can be the case that the social networks expose raw trend summaries independent of time periods. In such a case, the architecture can monitor these raw summaries and impose time spans on select segments of the raw trend summaries to further refine popular topics (units of information) for any desired time period. In other words, a social network may simply expose time-stamped data which the disclosed architecture can process to surface the top popular units of information.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

FIG. 1 illustrates a system 100 in accordance with the disclosed architecture. The system 100 can include an access component 102 that accesses disparate collections of social media trend data summaries 104 (104₁, 104₂, . . . , 104_{N}) of correspondingly disparate social networks 106 (106₁, 106₂, . . . , 106_{N}). The trend summaries include social network data that comprise hashtags, keywords, media, links, questions, and/or updates. The access component 102 can be any API (application program interface) suitably written to enable access to such trend data summaries 104 developed by each of the social networks 106. The social media trend data summaries 104 are commonly related to a given period of time. That is, although each social network may expose the trend data summaries over greater periods of time (e.g., weeks, months, etc.), the desired summaries extracted from the trend data summaries may be over a shorter period of time (e.g., hours, days, etc.).

Accordingly, a derivation component 108 derives popular units of information 110 from the trend data summaries 104 of the disparate networks 106. The derivation component 108 can derive these popular units of information 110 based solely on the trend data summaries 104, and not from user-supplied queries (identification) for specific units of information. The derivation component 108 can also annotate and index the units of information according to time.

An aggregation component 112 aggregates the popular units of information 110 into an aggregated view 114. The aggregated view 114 characterizes social activity for the given period of time (e.g., hours, days, etc.) by showing a temporal view in the form of a chart, keywords, hashtags (for Twitter social network), links, media (e.g., images, videos, etc.) and ranked snippets of information related to the keywords and/or hashtags, for example. Other views can be composed as desired, and can be customizable by the viewer/user, and for a given device.

The aggregated view 114 can be a collection of separate summaries from each of the accessed social networks. That is, the trend summary from the first social network, the trend summary from the second social network, the trend summary for the third social network, and so on, all displayed in the same aggregated view 114. Alternatively, the aggregated view 114 can be a composite of the top units of information from all of the accessed social networks. That is, three hashtags can be computed to be the top popular hashtags from different social networks that use hashtags, for example, and hence, presented as an aggregated set of hashtags in the aggregated view 114.

Similarly, multiple instances of top popular media from the first social network and a respective top popular set of media from the second social network can be depicted as separate sets of media in the aggregated view 114, or alternatively, the top popular media from the two sets can be illustrated as a single ranked media set in the aggregated view 114. This same principle applies to the other sets of information presented in the aggregated view 114. Still alternatively, a combination of separate and consolidated sets can be presented in the aggregated view 114.

As described herein below, a microprocessor can execute computer-executable instructions associated with at least one of the access component, the derivation component, or the aggregation component to facilitate knowledge discovery (data trends) in the social networks.

The creation of the social media trend data summaries 104 may be facilitated by a search engine that is configured to process social communications of a social network. The social communications of a network can be searched according to a specific time period. In operation, the search engine (or related process) accesses a store or feed of social communications of a network and parses the social communications into collections social communications according to time periods. The collections are processed such that a representative set of social communications related to units of information (also referred to as the social media trend data summaries) of the time period are computed. The social media trend data summaries for a network are then stored in a content store of the associated network. In other words, each social network 106 may have numerous stored trend data summaries for the configured periods of time. Accordingly, FIG. 1 shows only a single trend data summary 104 for each network 106 being accessed for a given period of time, when in fact each network 106 will have multiple sets of trend data summaries.

The access component 102 will then access trend data summaries 104 across the social networks 106 for a specific period of time. The choice of the period of time can be automatically determined for the consumer (e.g., a user) to be the most recent, for example, so that the consumer sees the currently popular units of interest. It can also be the case, however, that the consumer wants to see historical trend information prior to the most recent trend data. This capability to go back further in time can be made selectable for the consumer. Where the consumer is a user, the user interface can be designed to accommodate selectivity that enables access to historical trend summaries as well as historical popular units of information.

It can be the case that these collections of representative sets of social media communications for a given period of time are not trending summaries that characterize trending topics, but simply raw social media data for a given period of time. In this instance, the access component 102 retrieves the social media data for a given period of time, and passes this raw social media data to the derivation component 108. The derivation component 108 can be designed to perform trend analysis on the representative sets of social media communications for the given period of time to compute trends associated therewith over the given period of time.

FIG. 2 illustrates an alternative system 200 that further comprises a presentation component 202 and a notification component 204. The presentation component 202 presents the aggregated view 114 for interaction with the popular units of information 110 of the social activity. The presentation component 202 can be any application that enables the presentation of data, such as a browser.

The presentation component 202 also enables selection of a unit of information to track over time, and enables browsing of the aggregated view 114 of the popular units of information 110 (as part of the aggregated view 114) to discover connections between the units of information, and study (observe) trends based on temporal information.

The system 200 can further comprise the notification component 204 that sends a notification 206 (e.g., email, text, tone, beep, audio, etc.) based on trend data or time. In other words, the notification 206 can be triggered for delivery in response to a change in trend data, change in trend units of information derived, the presence of new trend data of one or more of the social networks, temporal data such as time/date of day, week, month, holidays, etc., and events locally, regionally, nationally, that may be occurring, about to occur, or have occurred, and so on.

In one implementation, the notification 206 can be triggered based on the notification component 204 operating in combination with a geographic location subsystem (e.g., global positioning system (GPS)) that identifies the current location of the device of a user, and based on the trending social media data, notifies the user of an event (item of interest) in the geographical area of the user. This notification can be provided based on user profile information or without this information as a means of filtering the notification and/or the content of the notification.

The trend data summaries 104 of the social networks 106 can comprise hashtags, keywords, media, links, questions, and/or updates. It can be the case that not every social network 106 provides the same information of another social network. For example, a social media trend data summary 104₁ of a first social network 106₁ can be based on keywords that are different than the keywords of social media trend data summary 104₂ of a second social network 106₂. Thus, ranking can be performed to compute the top ranked x number of keywords for ultimate presentation in the aggregated view 114. This process applies as well to different types of media (e.g., text, image, video, etc.) across the social networks 106 computed as the top or most popular content in the period of time being considered.

The derivation component 108 annotates and indexes the units of information according to time. The access component 102 can further access personal information 208 of the user (consumer) receiving the aggregated view 114 and the derivation component 108 derives the popular units of information 110 in view of the personal information 208. The personal information 208 can be obtained from sources such as user login profile, subscription profile for a given social network, from user configurable settings provided in accordance with the disclosed architecture, obtained from the destination device that will ultimately present the aggregated view 114, based on the application presenting the aggregated view 114, and so on.

It can also be processed in a different way, such that the personal information 208 is used to influence sending of the notification 206, generally, sending of the notification 206 to a specific destination device, sending to select ones of the user devices, when to send the notification 206, used to filter the amount and/or types of trend information (e.g., keywords, entities, updates, etc.) presented in the aggregated view 114, and so on. These options can be made consumer configurable.

The system 200 also includes an indexing component 210 that indexes the information into an index—a data structure with the entity as the key and list of summaries associated to that entity as the value. This data structure can be queried in realtime, and is used to populate the aggregated view 114 in the interface utilized by the user.

The systems 100 and 200 can be part of a search engine platform via which a user queries social activities as computed from the social networks. Not only can the query return typical search results from the search engine, but also social activities relate to the query from across numerous social networks.

FIG. 3 illustrates an exemplary aggregated view 114 in accordance with the disclosed architecture. The aggregated view 114 can show a temporal view 300 of given keywords in the form of a chart or graph where time is on the horizontal axis and a popularity measure is on the vertical axis. The view 114 can also include a keywords graphical illustration 302 where a popular set of ranked keywords are graphically presented for viewing. A links section 304 presents a ranked set of links associated with the top popular units of information. A social network tags section 306 presents a ranked set of hashtags, for the Twitter social network, as one example. A media section 308 presents ranked types of media such as text, images, videos, etc., for example. A keyword-related tag section 310 presents ranked content associated with the hashtags ranked in the tags section 306. These are only a few examples of the information that can be presented in the aggregated view 114, as obtained from multiple social networks.

FIG. 4 illustrates a more specific exemplary aggregated view 400 based on the generalized aggregated view 114 of FIG. 3. The aggregated view 400 shows the sources of the social networks so the viewer knows where the information is coming from and/or gets an idea of which sources are active places that discuss the entity that the user has selected. The view aggregated 400 includes the temporal view 402 (according to the temporal view 300 of FIG. 3), which is a grid-style graph where the horizontal axis is time that spans a daily increments of 21-29 October, and a vertical axis that spans popularity values of 550-800. Other axes dimensions can be utilized as desired. The temporal view 402 is user interactive thereby enabling the viewer to select specific points on the graph to view (or cause to display) relevant information for that selected point. For example, here, the viewer has selected a date of 23 October, which relate to the day of the peak popularity value (740) for the time span of October 21-29. The peak value and other points of the graph are computed as processed across the multiple social networks.

Either automatically or in response to the viewer interacting therewith, a dialog box 404 appears showing additional details about the peak value. For example, the dialog box 404 can include an image 406 can be presented that relates to the top popular unit of information (President Obama), textual content (Barack Obama), a hashtag (#BarackObama), a link object (L1) that when selected navigates the viewer to the source (e.g., webpage) associated with the link assigned to the object, and a Popularity designator (Popularity: High), that provides a textual indication of the popularity measure (High) for that specific point. Separately, or in combination therewith, an annotation 408 is presented on the graph, where the annotation 408 includes the date of the selected peak popularity point, and the popularity value (e.g., 740). This annotation 408 can be presented regardless of the viewer-selected point of interest. In this case, it will automatically track the peak popularity value for the present time span and present the intersection values (date and popularity value) for that point. Thus, the viewer can then use the annotation 408 as a means for further investigation of the point, in which case, the dialog box 404 can be enabled for more details.

In another implementation, the presentation component 202 can enable capabilities such that the user can drag the dialog box along the linear graph, and in response, the presentation component 202 will automatically and dynamically show the associated point information in the dialog box 404 based on the position of the box 404 on points of the linear segments of the graph.

Although the temporal view 402 shows a nine-day time span, it is to be understood that the time span can be a greater or lesser number of units per time. For example, the time span (period) can be presented in dimensions of weeks, months, hours, quarter hours, minutes, etc.

In another implementation, rather than looking as blocks of the most recent “historical” information, the aggregated view 400 can be continuously updated in realtime or “substantially” realtime according to configured time increments of realtime, minutes, hours, for example, such that the viewer will see changing aggregated content in realtime, relatively realtime, by the minute, by the hour, etc. Thus, the temporal view 402 will actively show a “rolling” (continuously updating) window of popularity tracking in the time span (e.g., minutes, hours). In coordination therewith, the other content (e.g., links, hashtags, keywords, media, tag-related content) in the aggregated view 400 may also change, and will be viewable as changing based on the changing increments of time corresponding changing (possible, maybe not) units of information over time.

The aggregated view 400 also shows a keywords section 410 that graphically represents the importance/popularity/ranking of keywords/terms (as units of information). Here, the terms “Mitt Romney”, “horses and bayonets”, “foreign policy”, “last debate”, and “vote”, are selected as the top popular keywords across the social networks. The keywords “Mitt Romney” are shown in the largest of five bubbles, the keywords “horses and bayonets” are shown in the second largest of the five bubbles, the keywords “foreign policy” are shown in the third largest of the five bubbles, the keywords “last debate” are shown in the fourth largest of the five bubbles, and the keyword “vote” is shown in the fifth largest of the five bubbles. The bubbles can be interactive such that user selection of a specific bubble automatically navigates the user to a source of related information.

The aggregated view 400 also shows a hashtags section 412 that lists in decreasing order of popularity (top down) a set of top hashtags computed from the multiple social networks. A tag-related content section 414 presents additional content written and sent by users and related to one or more of the hashtags presented in the hashtags section 412.

As previously indicated, the aggregated view 400 shows the sources of the social networks so the viewer can identify where the information is coming from and/or gets an idea of which sources are active places that discuss the entity that the user has selected. Accordingly, a links section 416 provides a ranked list of destination pages (documents) from the one or more social networks that can be navigated to and that comprise one or more of the popular units of information. The top link (“About those horses . . . ”) can be identified as from a first social network (e.g., Twitter), and the bottom link (“Know your Meme-Horses . . . ”) can be from a second social network (e.g., Quora™). This identification can be made from the URL link information, for example, and/or be annotated separately next to the given link. Thus, in the top link, although the link information indicates otherwise, the link can be sourced from Twitter. The separate annotation proximate the link can then be something similar to “as obtained from Twitter”, or the like. A media section 418 similarly presents a ranked list of media related to the top units of information computed for the period of time. Each of the media presented in the media section 418 can be selected (interacted with) to navigate to the source(s) of the selected media.

FIG. 5 illustrates an exemplary notification 500 that presents an aggregated view of a trend summary across the social networks to a user. The notification 500 can include portions or all of the aggregated view 114. In other words, a filter can be applied that enables the user to see what they want to see. It can be the case that the user chooses to only see the trends from the first and third social networks, for example. This can be made selectable in the user interface for any application suited to present such summary information 502.

The notification 500, being in the form of a message, may include communications header information 502 that shows the sender of the summary information, time of transmission, date, and other information commonly utilized for message transmission. In this example, the trend(s) are obtained for a period of one week. Accordingly, an informative description in the message can be “Favorites Trending This Week”. The summary information 502 (also referred to as a notification view) can include the first social media trend summary 104₁ of the first social network 106₁, the second social media trend summary 104₂ of the second social network 106₂, a consolidated summary 504 of third and fourth summaries (104₃ and 104₄) of the corresponding social networks (106₃ and 106₄), a first set of ranked hashtags 506 and a second set of ranked hashtags 508, hashtag-related content 510, a first set of media 512 and a second set of media 514.

FIG. 6 illustrates a system 600 of indexing keys and summaries into an index 602 that can be queried in realtime for population of the aggregated view in accordance with the disclosed architecture. The system 600 shows the social media networks 106 each having zero, one, or more social media trend data summaries 104 that are accessible for a given span of time. As part of derivation, the derivation component 108 derives the popular units of information (UoIs) from the accessible summaries 104. The top summaries are then passed to the indexing component 210 for creation of the index 602. The aggregation component 112 can then access the index 602 in realtime in response to preparing the aggregated view 114 for the consumer (e.g., user).

The data structure of the index 602 can be defined in many different ways, one example of which is described. Here, the index 602 shows index entries 604 in the following format:
UoI-x:SNy:TS=z dim; SD=mm/dd/yyyy
   where UoI-x is an x-th unit of information, SNy is an attribute defined as the y-th social network, TS is a time span z attribute for a time dimension of dim (e.g. minutes, hours, days, weeks, months, etc.), and SD is a start date mm/dd/yyy attribute of the time span. Thus, the UoI can be a keyword, hashtag, media, link (e.g., URL (uniform resource locator)), etc. Each of these attributes is also defined to be a unit of information.

It is to be understood that this is just one example data structure format, since additional and/or different information can be utilized, such as an NA value for a given social network 106 that was accessible yet did not have an updated or accessible trend summary, a last-time-updated (LTU) value that indicates the recency (occurrence relative to an event or a point in time) of the index entry, a media type (MT) value to indicate the media type such as text, image, video, user identifier of an author (AUT) making/creating the social content, and so on. As shown, the data structure of the index 602 utilizes the UoI as the key. In this way, it is then possible to derive from the trend summaries, the unit of information related to a given author over time as well.

The index 602 can also be searched based on any one or more of the attributes. For example, the user (consumer) can search for all entries of a specific time span, unit of information, or any combination thereof, and so on, to find all index entries related to the searched one or more units of information.

It can be the case of indexing all the units of information from all accessible trend summaries across the social networks for a given time span, and then deriving the top popular units of information therefrom, rather than indexing only the top popular units of information.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

FIG. 7 illustrates a method in accordance with the disclosed architecture. At 700, social media trend summaries of multiple social media networks are accessed. This can be accomplished by utilizing suitably design interfaces that enable access to these summaries. At 702, the top popular units of information are extracted from the social media trend summaries in a specific span of time. At 704, the top popular units of information are aggregated as an aggregated view. A microprocessor can be configured to execute instructions in a memory associated with the acts of accessing, extracting, and/or aggregating.

The method can further comprise selecting a unit of information and tracking the unit of information over time, as viewed in the aggregated view. The method can further comprise sending a notification based activity of a unit of information. The method can further comprise presenting the aggregated view as interactable (capable of being interacted with), the aggregated view including an interactive temporal view of a trending unit of information over the specific span of time. The method can further comprise indexing the top popular unit of information for realtime access and view creation of the aggregated view. The method can further comprise presenting in association with the aggregated view of units of information, a graphical indication of the social networks from which the units of information are derived. The method can further comprise navigating to a new document associated with a unit of information in response to interaction with the unit of information.

FIG. 8 illustrates an alternative method in accordance with the disclosed architecture. At 800, social media trend summaries of multiple social media networks are accessed. At 802, top popular units of information are extracted from the social media trend summaries in a specific span of time. At 804, an index of the top popular units of information is created. At 806, the index is searched for the top popular units of information in realtime based on a query. At 808, the searched top popular units of information are aggregated as an aggregated view. At 810, the aggregated view is presented with interactive units of information. A microprocessor can be configured to execute instructions in a memory associated with at least one of the acts of accessing, extracting, creating, searching, aggregating, or presenting.

The method can further comprise sending periodic notifications to a consumer, where the notifications relate to a unit of information of interest. For example, the unit of information may be an event that is currently occurring over a 4-day span of time. The user can then receive regularly-scheduled emails about the event, as commented about in the social networks.

The method can further comprise presenting in the aggregated view a timeline view of a change in popularity of a top popular unit of information over a dimension of time. The timeline can be utilized to filter other view information. For example, if the user selects a point on the timeline, portions of the other data in the aggregated view changes based on the selected point or time span defined in the timeline view. In other words, if the user highlights a span of two days in the temporal view, other information in the aggregated view is filtered to only include information for that highlighted span of two days.

The method can further comprise browsing to other documents related to a unit of information in response to interaction with the unit of information. When a user interacts with (e.g., clicks on) a unit of information, the user interface can navigate to the document linked to the unit of information, or insert the unit of information as a new query in the search engine. The method can further comprise computing a weight for each unit of information and ranking the units of information by weight to obtain the top popular units of information.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

Referring now to FIG. 9, there is illustrated a block diagram of a computing system 900 that executes knowledge discovery using social media collections of information in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 9 and the following description are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904 (also referred to as microprocessor(s) and processor(s)), a computer-readable storage medium such as a system memory 906 (computer readable storage medium/media also include magnetic disks, optical disks, solid state drives, external memory systems, and flash memory drives), and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 902 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 906 can include computer-readable storage (physical storage) medium such as a volatile (VOL) memory 910 (e.g., random access memory (RAM)) and a non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the system memory 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes machine readable storage subsystem(s) 914 and storage interface(s) 916 for interfacing the storage subsystem(s) 914 to the system bus 908 and other desired computer components. The storage subsystem(s) 914 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a machine readable and removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The operating system 920, one or more application programs 922, other program modules 924, and/or program data 926 can include entities and components of the system 100 of FIG. 1, entities and components of the system 200 of FIG. 2, entities and components of the view 114 of FIG. 3, entities and components of the view 400 of FIG. 4, entities and components of the notification 500 of FIG. 5, entities and components of the system 600 of FIG. 6, and the methods represented by the flowcharts of FIGS. 7 and 8, for example.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) can be any available media (medium) that do (does) not employ propagated signals, can be accessed by the computer 902, and includes volatile and non-volatile internal and/or external media that is removable and/or non-removable. For the computer 902, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 902, programs, and data using external user input devices 928 such as a keyboard and a mouse, as well as by voice commands facilitated by speech recognition. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example.

These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP-based) using logical connections via a wired/wireless communications subsystem 942 to one or more networks and/or other computers. The other computers can include workstations, servers, routers, personal computers, microprocessor-based entertainment appliances, peer devices or other common network nodes, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an access component that accesses disparate social media trend data summaries of correspondingly disparate social networks, the social media trend data summaries commonly related to a given period of time;
a derivation component that derives popular units of information from the disparate trend data summaries;
an aggregation component that aggregates the popular units of information into an aggregated view, the aggregated view characterizes social activity for the given period of time; and
a microprocessor that executes computer-executable instructions associated with at least one of the access component, the derivation component, or the aggregation component to facilitate knowledge discovery in social networks.

2. The system of claim 1, further comprising a presentation component that presents the aggregated view for interaction with the popular units of information of the social activity.

3. The system of claim 1, further comprising a presentation component that enables selection of a unit of information to track over time.

4. The system of claim 1, further comprising a presentation component that enables browsing of the aggregated view of the popular units of information to discover connections between the units of information, and study trends based on temporal information.

5. The system of claim 1, further comprising a notification component that sends a notification based on trend data or time.

6. The system of claim 1, wherein the trend summaries include social network data that comprise at least one of hashtags, keywords, media, links, questions, or updates.

7. The system of claim 1, wherein the derivation component annotates and indexes the units of information according to time.

8. The system of claim 1, wherein the access component further accesses personal information and the derivation component derives the popular units of information in view of the personal information.

9. A method performed by a computer system executing machine-readable instructions, the method comprising acts of:
accessing social media trend summaries of multiple social media networks;
extracting top popular units of information from the social media trend summaries in a specific span of time;
aggregating the top popular units of information as an aggregated view; and
configuring a microprocessor to execute instructions in a memory associated with at least one of the acts of accessing, extracting, or aggregating.

10. The method of claim 9, further comprising selecting a unit of information and tracking the unit of information over time, as viewed in the aggregated view.

11. The method of claim 9, further comprising sending a notification based activity of a unit of information.

12. The method of claim 9, further comprising presenting the aggregated view as interactable, the aggregated view including an interactive temporal view of a trending unit of information over the specific span of time.

13. The method of claim 9, further comprising indexing the top popular unit of information for realtime access and view creation of the aggregated view.

14. The method of claim 9, further comprising presenting in association with the aggregated view of units of information, a graphical indication of the social networks from which the units of information are derived.

15. The method of claim 9, further comprising navigating to a new document associated with a unit of information in response to interaction with the unit of information.

16. A method performed by a computer system executing machine-readable instructions, the method comprising acts of:
accessing social media trend summaries of multiple social media networks;
extracting top popular units of information from the social media trend summaries in a specific span of time;
creating an index of the top popular units of information;
searching the index for the top popular units of information in realtime based on a query;
aggregating the searched top popular units of information as an aggregated view;
presenting the aggregated view with interactive units of information; and
configuring a microprocessor to execute instructions in a memory associated with at least one of the acts of accessing, extracting, creating, searching, aggregating, or presenting.

17. The method of claim 16, further comprising sending periodic notifications to a consumer, the notifications related to a unit of information of interest.

18. The method of claim 16, further comprising presenting in the aggregated view a timeline view of a change in popularity of a top popular unit of information over a dimension of time.

19. The method of claim 16, further comprising browsing to other documents related to a unit of information in response to interaction with the unit of information.

20. The method of claim 16, further comprising computing a weight for each unit of information and ranking the units of information by weight to obtain the top popular units of information.
